(19) United States
(12) Patent Application Publication
(10) Pub. No.: US 2007/0075678 A1
(43) Pub. Date: Apr. 5, 2007

(54) Life cycle extending batteries and battery charging means, method and apparatus

(75) Inventors: Andrew Sung On Ng, Jardines Lookout (CN); Peter Pui Tsang Ling, Ontario (CA); Kin Pun Wong, Singapore (SG)

Correspondence Address: BUCHANAN, INGERSOLL & ROONEY PC, POST OFFICE BOX 1404, ALEXANDRIA, VA, 22313-1404, US

(73) Assignee: Andrew Sung On NG, Jardines Lookout (CN)

(21) Appl. No.: 11/542,231

(22) Filed: Oct. 4, 2006

Related U.S. Application Data
(63) Continuation-in-part of application No. 10/737,915, filed on Dec. 18, 2003, now abandoned.

(30) Foreign Application Priority Data
Dec. 20, 2002 (CN) 02109262.0

(51) Int. Cl. H02J 7/00

(52) U.S. Cl. 320/106

(57) ABSTRACT

A method of battery charging includes a first step of collecting characteristic battery data of the battery. This characteristic battery data relates to charging characteristics of the battery and includes charging current rate, ambient temperature, battery voltage and state-of-charge of the battery. A full charge voltage of the battery is determined, which corresponds to a state of full charge of the battery. A stop-charge voltage is determined, this stop-charge voltage being below the full charge voltage and being a voltage above which the rate of increase of battery temperature begins to increase. The ambient temperature is determined, and a charging current rate is selected. The battery is charged until the stop-charge voltage is reached.

### FIELD OF THE INVENTION

The present invention relates to battery charging and, more particularly, to means, apparatus, systems and methods for battery charging. More specifically, although of course not solely limited thereto, this invention relates to charging apparatus and methods for charging batteries with an aim of extending the useable life or useable life cycles of a rechargeable battery. This invention has a particular, although not specific, relevance to battery charging for lap-top computers.

### BACKGROUND OF THE INVENTION

Rechargeable batteries are used in a wide variety of applications and are preferred in many applications because they have a longer operating life, are more environmentally friendly and are more economical in the long run. For example, rechargeable batteries are used in portable devices such as mobile phones, lap-top or hand-held computers and other portable communication equipment. In addition, rechargeable batteries are also used in more heavy-duty applications such as electrical vehicles, hybrid electrical vehicles or other transportation equipment. In general, the operating costs of rechargeable batteries are substantially less than the capital or replacement costs of batteries, especially batteries of a large capacity. Hence, it would be highly desirable and in the interest of the public to provide batteries with a longer operating life as well as means, methods or apparatus for extending the operating life of batteries beyond the normally expected life-span.

Typically, a rechargeable battery is fully charged after each discharge cycle and then reused. The overall useable life of a rechargeable battery is usually characterised by the number of successful charge-and-discharge cycles which the battery can undergo. It is well known that a rechargeable battery has a limited usable life and its capacity will gradually diminish after repeated cycles of charging and discharging. When the full capacity of the battery falls below a critical value, it will be pronounced “dead”. A commonly or usually accepted critical value at which a rechargeable battery is pronounced “dead” is 80% of its initial capacity. Thus, many battery-operated systems are designed to function well even when the capacity of the battery has dropped to near this critical capacity.

In order to maximise the time interval between successive battery charging or to reduce the battery charging frequency, so that a maximum travel range (in the case of electrical vehicles) or a maximal utilisation duration can be obtained before each recharging, it is customary to charge rechargeable batteries to their full capacity before the next discharge.

Conventional intelligent charging apparatus or methods are usually designed to ensure that the battery is in fact fully charged and will not in its normal operation cease charging until the “full charge” or peak charging voltage has been detected and confirmed. This peak charging voltage may be confirmed, for example, by the detection of a “−ΔV” signal by comparison of the successive battery terminal voltages, by identifying the beginning of the change of the charging slope or by other appropriate methods. Usually, termination of charging by detection of the occurrence of the “−ΔV” signal of say 5 mV/cell, the change of the charging slope or other characteristic peak charging signals means that the battery is already slightly overcharged, for example, to 105% of its nominal capacity.

It has been observed that Nickel based rechargeable batteries, for example, nickel cadmium (NiCd) and nickel metal hydride (NiMH) batteries, have a relatively short usable life cycle of only up to a few hundred charging-and-discharging cycles if they are subject to repeated charging using conventional charging methods in which charging is terminated upon the detection of the appearance of the characteristic full charge signals such as the “−ΔV” signal in each charging cycle. On the other hand, the characteristic full charge signals, such as the “−ΔV” signal, provide a good and useful reference as well as increased certainty indicating that the battery has been charged to an adequate or appropriate capacity.

Thus, it will be highly desirable if there can be provided means, apparatus, methods and systems for battery charging to alleviate shortcomings of conventional charging means, methods, apparatus and systems so that the operating life cycles of rechargeable batteries, in particular NiCd and NiMH batteries, can be optimised or extended while providing a reasonable degree of certainty that the battery has been charged to a satisfactory pre-determined level. It will be noted that as the number of usable operating cycles of a rechargeable battery increases, the capital cost per usable cycle decreases. Hence, it is also desirable for the benefit of the public if there can be provided means, methods and apparatus for charging batteries, in particular NiCd and NIMH batteries, which extend battery operating life cycles.

Furthermore, it will be appreciated that as the intervals between battery replacements are extended, maintenance costs of systems incorporating such improved charging methods, such as, for example, power plant load levelling systems, and apparatus, such as electrical vehicles, buses, scooters, bicycles and the like, will also decrease. Thus, it will be appreciated that such improved battery charging means, methods and apparatus will also contribute to environmental protection as the disposal of used batteries has always been an environmental concern.

### OBJECT OF THE INVENTION

Accordingly, it is an object of the present invention to provide battery charging methods, as well as means and apparatus which will alleviate the shortcomings of conventional charging methods, apparatus and systems so that the operating life cycles of rechargeable batteries, in particular NiCd and NiMH batteries, can be optimised or extended while providing a reasonable degree of certainty that the batteries are charged to an optimal or satisfactory level.

At a minimum, it is an object of the invention to provide the public with a useful choice of battery charging means, apparatus and methods.

### SUMMARY OF THE INVENTION

According to the present invention, there is provided a method of battery charging comprising the steps of:
collecting characteristic battery data of the battery, said characteristic battery data relating to charging characteristics of the battery and including charging current rate, ambient temperature, battery voltage and state-of-charge of the battery;
determining a full charge voltage of the battery, said full charge voltage corresponding to a state of full charge of said battery;
determining a stop-charge voltage, said stop-charge voltage being below said full charge voltage and being a voltage above which the rate of increase of battery temperature begins to increase;
determining the ambient temperature, and selecting a charging current rate; and
charging the battery until said stop-charge voltage is reached.

By charging a battery with reference to a stop-charge of the battery, the risks of battery overheating will be mitigated.

In a preferred embodiment, said stop-charge voltage is pre-set at a pre-determined voltage value with reference to a state of charge of said battery, and said stop-charge voltage is adjustable from said pre-determined voltage value by a user to correlate to a target state-of-charge of said battery. By allowing a user to vary the actual stop-charge voltage through selecting a target state-of-charge, the battery capacity to be charged can be varied to suit different applications.

Advantageously, said target state-of-charge of said battery is above 80% but below 100% of the full state-of-charge of said battery. A charging range of between 80% and below 100% battery capacity provides a good balance between a long battery life and battery capacity.

In the present example, said stop-charge voltage is a pre-set variable which is pre-determined with reference to the ambient temperature, the charging current rate and an initial target state of charge, and said stop-charge voltage is subsequently variable with reference to a revised target state of charge of said battery which is selectable by a user.

Advantageously, said stop voltage is adjustable by extrapolation from said pre-determined voltage value and with reference to the state of full charge of said battery.

In a preferred example, said stop-charge voltage is pre-set at a pre-determined value, and said pre-determined value is pre-set at a value which is at below 85% of said full charge voltage.

In order to maintain an accurate tracking of the battery capacity, it will be advantageous if the instantaneous state of full charge of the battery being charged is repeatedly measured during the useful life of said battery.

In a preferred example, the instantaneous state of full charge of the battery is determined by battery voltage measurements.

As a convenient example, the instantaneous state of full charge of the battery is determined by measurement of the rate of change of battery voltage when under battery charging conditions.

In a specific example, the instantaneous state of full charge of the battery is determined by detection of occurrence of a −ΔV condition.

Preferably, the value of said stop-charge voltage is revised after measurement of the instantaneous state of full charge of the battery being charged.

In another aspect of this invention, there is provided the battery charger comprising a controller for collecting characteristic battery data, a memory for storing said collected characteristic battery data and a charging current source, said characteristic battery data relating to charging characteristics of the battery and including charging current rate, ambient temperature, battery voltage and state-of-charge of the battery; wherein said controller is adapted to:
determine a full charge voltage of the battery, said full charge voltage corresponding to a state of full charge of said battery;
determine a stop-charge voltage, said stop-charge voltage being below said full charge voltage and being a voltage above which the rate of increase of battery temperature begins to increase;
determine the ambient temperature, and selecting a charging current rate; and
control said charging current source to provide charging current to the battery until said stop-charge voltage is reached.

Preferably, said charging current source being a constant current source.

In a further aspect of this invention, there is provided a computer comprising a battery charger described herein.

According to another aspect of the present invention, there is provided the battery charging method including the steps of:-
i. ascertaining or determining the characteristic “full charge” voltage of the battery while being charged,
ii. charging said battery,
iii. monitoring and recording the on-charge voltage of said battery,
iv. repeating steps ii. and iii. and effectively stop charging of said battery when a pre-determined maximum charging voltage has been reached,
wherein said pre-determined maximum charging voltage being lower than said characteristic full charge voltage of said battery by a pre-determined charging voltage margin and said pre-determined maximum charging voltage being reached before said characteristic full charge voltage is reached.

By ascertaining the characteristic “full charge” voltage of the battery and then to stop charging the battery at the pre-determined maximum charging voltage (which is lower than the characteristic full charge voltage), an optimal charging to give a satisfactory charge capacity while alleviating damage to the battery can be achieved.

To materialize the first aspect above, there is provided in a second aspect of the present invention the battery charger including:-
i. means for ascertaining the characteristic full charge voltage of said battery and setting a pre-determined maximum charging voltage based on said characteristic full charge voltage and a pre-determined charging voltage margin,
ii. charging means for charging said battery,
iii. data acquisition means for reading and recording the terminal voltage of said battery,
iv. comparison means to compare said terminal voltage with said pre-determined maximum charging voltage,
v. control means to effectively stop charging of said battery when said pre-determined maximum charging voltage value has reached,
wherein said pre-determined voltage value being lower than said characteristic full charge voltage value of said battery and said pre-determined voltage value being reached before said characteristic full charge voltage is reached.

In a preferred realization of the another aspect of the present invention, charging means is incorporated into the battery and hence, according to a third aspect of the present invention, there is provided the battery including:-
means for ascertaining the characteristic full charge voltage of said battery and setting a pre-determined maximum charging voltage based on said characteristic full charge voltage and a pre-determined charging voltage margin,
charging means for charging said battery,
data acquisition means for reading and recording the terminal voltage of said battery,
comparison means to compare said terminal voltage with said pre-determined maximum charging voltage,
control means to effectively stop charging of said battery when said pre-determined maximum charging voltage value has reached,
wherein said pre-determined voltage value being lower than said characteristic full charge voltage value of said battery and said pre-determined maximum charging voltage being reached before said characteristic full charge voltage is reached.

To implement the above battery charging method of another aspect of this invention, there is provided in another aspect of the present invention the battery charger including
means for determining the characteristic full charge voltage of the battery, said characteristic full charge voltage being used as a reference to determine a maximum charging voltage of said battery,
control means to effectively end charging at or before said maximum charging voltage ascertained according to parameters measured during a characterisation charging cycle of said battery before said characteristic full charge voltage is reached.

In a preferred embodiment, the characteristic “full charge” voltage of said battery is ascertained by identifying the maximum on-charge battery terminal voltage of said battery during a characterising charging cycle of said battery.

Preferably, said characteristic “full charge” voltage being equal to the on-charge voltage of said battery at the occurrence of a negative charging slope (or the −ΔV phenomenon). As the characterization of the “full charge” voltage will be done only after a pre-determined number charge-and-discharge cycles, adverse influence to the battery will be minimal.

As rechargeable batteries are increasingly charged under fast charging conditions, that is, at 1-C or higher current rate, both said characterising charging process and the repeated charging cycles of said battery are both conducted generally in the region of the 1-C charging rate.

Preferably, both said characterising charging process and the repeated charging cycles of said battery are conducted generally at the same charging current.

Experiments show that this invention is particularly good for the battery including a Nickel Metal Hydride cell.

As the conditions of the battery will deteriorate with time, step i. of said charging method is preferably repeated after a pre-determined period of time has elapsed or after a pre-determined number of charging cycles has elapsed, so that an updated characteristic full charge voltage value is obtained for setting an updated pre-determined maximum charging voltage for use in step iv.

In a preferred embodiment, the pre-determined maximum charging voltage for use in step iv. is increased by a predetermined amount after a pre-determined number of charging cycles has elapsed, since the characteristic full charge voltage will increase with time due to battery conditions deterioration.

In a preferred embodiment, said pre-determined maximum charging voltage is set at not more than 90 mV below said characteristic full charge voltage of said battery.

In yet another preferred embodiment with more sophisticated charge voltage control means, the pre-determined maximum charging voltage is set at not more than 75 mV below said characteristic full charge voltage of said battery.

Preferably, step i. of said charging method further including the step of measuring the temperature of said battery before step iv. is performed, said maximum charging voltage as determined by said characteristic full charge voltage and said pre-determined charging voltage margin in step iv. being adjusted according to the measured temperature of said battery.

To provide further and additional efficacy, the maximum charging voltage being preferably adjusted by reference to a pre-determined negative temperature coefficient.

### BRIEF DESCRIPTION OF THE DRAWINGS

Preferred embodiments of the present invention will be explained in further detail below by way of examples and with reference to the accompanying drawings, in which:-

FIG. 1 is a diagram showing graphs comparing the variation of battery capacity against the number of charging-and-discharging cycles of, as an example, Nickel Metal Hydride batteries of the same rated capacity when the batteries are charged conventionally (graph A) and according to a first embodiment of the present invention (graphs B & C),

FIG. 2 is a diagram showing graphs comparing the variation of battery capacity against the number of charging-and-discharging cycles of the example Nickel Metal Hydride battery of FIG. 1 above when the batteries are charged conventionally (graph A) and according also to a first embodiment of the present invention (graph D),

FIGS. 3 to 5 are flow charts showing the general principles of operation of the present invention,

FIG. 6 is a block diagram showing an intelligent battery and an intelligent charging apparatus of the present invention, and

FIG. 7 shows graphs of battery charging at various charging current rates at an ambient temperature of 25° C.,

FIG. 8 shows graphs of battery charging at various charging current rates at an ambient temperature of 35° C.,

FIG. 9 are graphs showing relationships between battery charging voltage and battery temperature at 0.5C and at various ambient temperatures, and

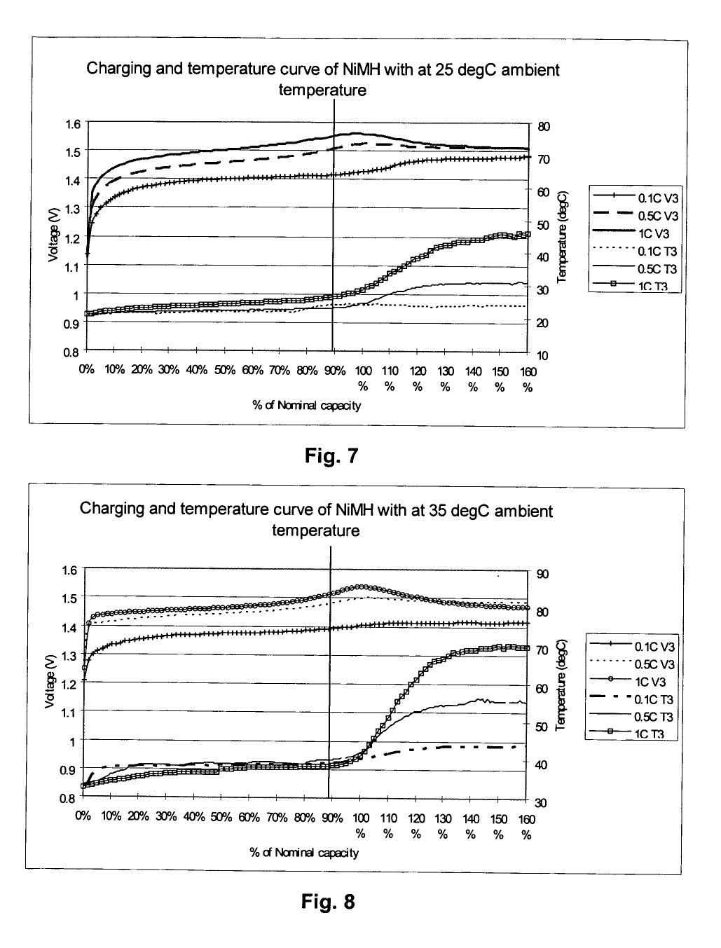

FIG. 10 are graphs showing relationships between battery charging voltage and battery temperature at 0.3C and at various ambient temperatures.

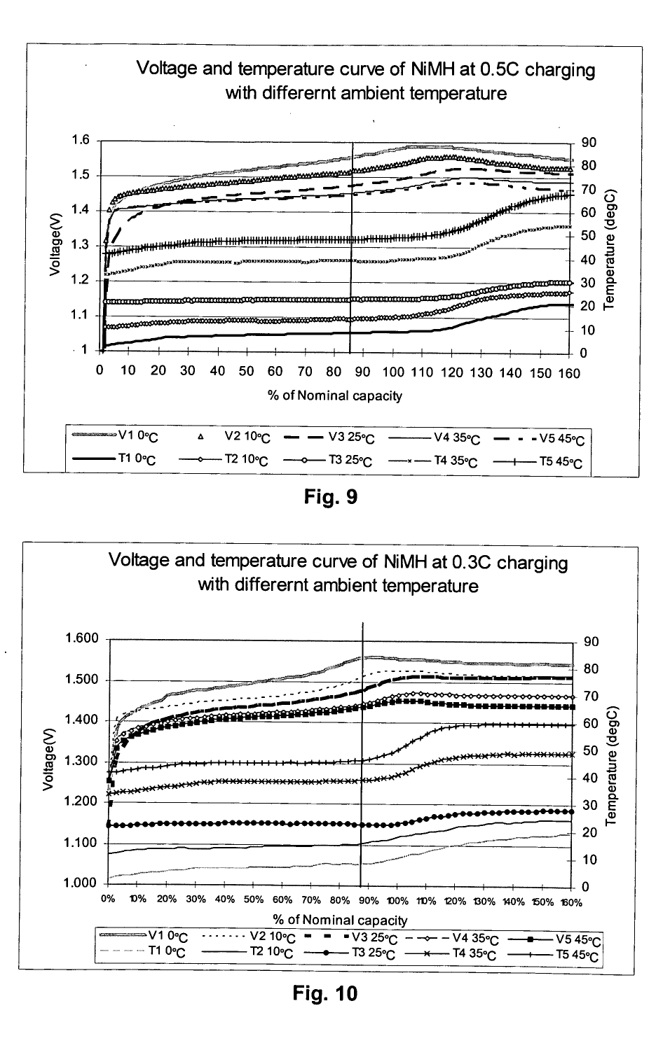

### DETAILED DESCRIPTION OF THE PREFERRED EMBODIMENTS

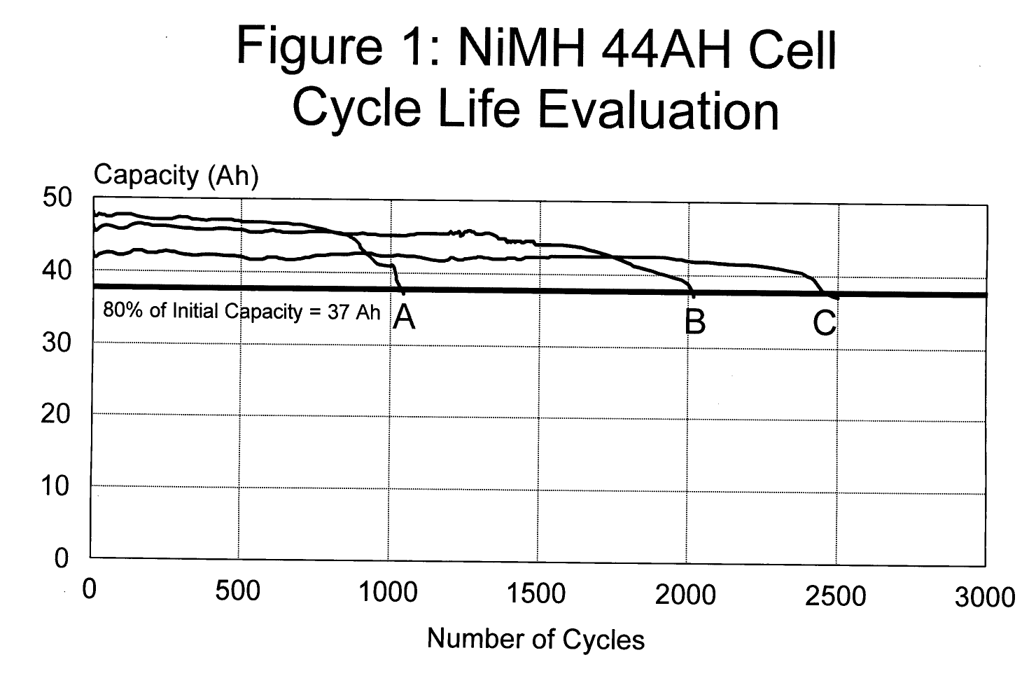

When a rechargeable battery is repeatedly charged and discharged during their operating life, its capacity gradually diminishes as the number of charging-and-discharging cycles increases. In graph A of FIG. 1, an example NiMH of 48 Ah rated capacity has been charged using conventional means and methods under which charging will be effectively terminated upon detection of the characteristic full charge voltage, which is commonly known as the minus delta V (−ΔV) signal.

As shown in the graph, it will be noted that the capacity of the battery falls to 80% of its rated capacity after undergoing about 1,000 charging-and-discharging cycles and the rate of capacity diminution is particularly noticeable between 750-1,000 cycles. In view of this known battery capacity deterioration characteristics and other reasons, battery operated devices, apparatus and systems are typically designed so that they will function well even when the battery capacity has fallen to 80% of its rated capacity. While 80% of the rated battery capacity is commonly and generally accepted as the standard critical battery capacity value, the specific percentage margin of battery capacity of course depends on the specific purposes or applications and can of course be varied without loss of generality.

In the study of the capacity behaviour of rechargeable batteries, it has been noted that a rechargeable battery which has been repeatedly charged to its full capacity by conventional charging methods has a shorter usable cycle life compared to a rechargeable battery of the same specification which is always charged below the full capacity.

Upon a closer examination of the battery characteristics and behaviour, it is observed that both the internal battery temperature and pressure rise rapidly as the battery approaches full charge. The increase in temperature and pressure within the battery causes and is an indication of electrode degradation and hence the reduction of cycle life of the battery. As conventional charging methods usually require the confirmation of full charge by detection of the occurrence of the characteristic full charge voltage by looking for a negative charging slope or a decrease in terminal voltage when the battery is subject to further charging, this means that the battery will inevitably be repeatedly overcharged and the accumulated damage will eventually shorten the battery cycle life. Furthermore, the battery that is charged in this manner will lose about 1-2% of its capacity if it is left idle after charge for a short time, say for example, 1 hour. It is understood that this 1-2% capacity represents the formation of unstable and undesirable chemical intermediates inside the battery, which are the likely causes of cycle life degradation. And since the capacity “disappears” so quickly after charge, it is not very valuable in practical application. The present invention teaches the forfeiture of this extra capacity will result in lower charge temperature and pressure within the battery, thereby enhancing the battery cycle life.

Therefore, in order to extend the life cycles of a rechargeable battery, issues of competing and, to some extent conflicting interest, namely, 1.) to charge the battery to the maximum usable battery capacity, while 2.) without exceeding the acceptable charging limits which will cause premature deterioration of battery capacity, have to be resolved or overcome. These are further complicated by the general necessity that the battery should be charged in the shortest possible time, for example, near or above 1-C rate, which means that the battery may be easily damaged once the battery is charged beyond the full-charged state.

In addition, the charge level of a rechargeable battery may not be quite predictable or easily ascertainable without unduly complicated circuitry and means or with reference to the well known electrical characteristics, such as the characteristic full charge voltage and the so-called “rated voltage” provided by manufacturers may not be always accurate. Hence, it is of practical benefit and significance that the charge capacity level of the battery is monitored or ascertained from time to time. In this regard, it will be appreciated that even if the battery capacity cannot be monitored absolutely accurately, it will be highly desirable for the practice of the present invention to avoid over-discharge of the batteries. To alleviate the risks of over-discharge, it is desirable that battery charging should be terminated if the on-load voltage of the battery falls below a critical level, for example, 1 volt per cell for nickel based batteries.

In the examples set out below, preferred embodiments of charging methods, an intelligent charging apparatus and an intelligent battery with means to alleviate the above competing requirements are described.

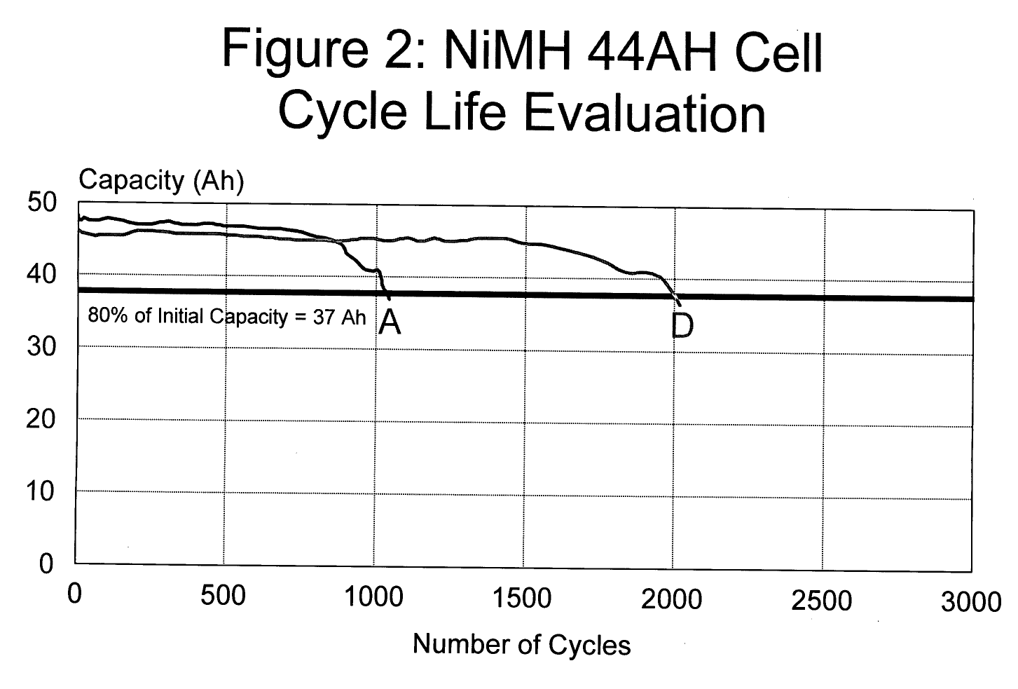

Referring to FIGS. 1 and 2, the battery capacity (Ah) versus the number of charging-and-discharging cycles of a plurality of NiMH batteries of the same design and specification are shown. The NiMH batteries used in the present example has a rated capacity of 48 Ah ampere-hour. The graphs show the different charging characteristics of the batteries when subject to different charging modes at the same charging rate (40 A). In particular, the battery as represented by graph was repeatedly charged by a conventional charging method and the batteries represented by graphs B, C and D are charged by methods of the present invention, albeit with slight variation in each of the charging modes. In the present examples, the data relating to battery capacity versus the number of charging cycles are only monitored to the usually accepted 80% level (37 Ah) of the initial rated capacity without loss of generality.

More specifically, the battery represented by graph A is repeatedly charged at a constant current of 40 Ah under ambient temperature until the −ΔV signal has been detected. The −ΔV signal is assumed to be confirmed by monitoring the battery voltage and when a drop of 5 mV has been detected during the charging process. The characteristic full charge voltage for this battery was measured to be 1.525V.

This battery was subjected to repeated cycle charging using the 5 mV −ΔV criteria so that charging will terminate upon the detection of the occurrence of a drop of 5 mV in the “on-charge” voltage of the battery. For the avoidance of doubt, the term “on-charge voltage” of the battery means the terminal voltage of the battery while being charged. After 850 cycles, the characteristic full charge voltage as determined by this −ΔV method was measured and found to have increased to a higher value of 1.545 volt. It is noted that increase in the characteristic full charge voltage is likely due to an increase in the internal resistance of the cell as it ages, deteriorates and dried out.

It is noted that the battery of graph A has a cycle life of about 1,000 cycles and the diminution in battery capacity begins to be particularly noticeable from about 750-800 cycles.

### EXAMPLE ONE (GRAPH B)

In this example, the same Nickel Metal Hydride battery of 48 Ah rated capacity with a full charge voltage of 1.525 V is used. Although the full charge voltage of a new battery can be estimated from established principles, the battery is nevertheless characterized to ensure an accurate full charge voltage.

Firstly, the full charge voltage of the battery in this specific example is ascertained by subjecting the battery to constant current charging at 40 A until the characteristic full charge voltage representing full capacity has been detected, measured or ascertained. The detection of the characteristic full charge voltage can, for example, be by the detection of the occurrence of the −ΔV signal, the change in the charging slope or other appropriate means. Thus, the characteristic full charge voltage is ascertained and confirmed upon the detection of a decrement of 5 mV in the on-charge voltage of the battery.

After the characteristic full charge voltage (V_{P1}) has been ascertained, subsequent charging cycles of the battery are to be terminated upon reaching a pre-determined maximum charging voltage which is below the characteristic full charge voltage V_{P1}. The maximum charging voltage is set to be below the characteristic full charge voltage V_{P1} by a “charging voltage margin”, which is defined for the present purpose as the voltage difference between V_{P1} and the actual termination voltage.

In this specific example, the characteristic full charge voltage as ascertained in the characterisation cycle is 1.525 volt and the charging voltage margin is set as 15 mV. Hence, the maximum charging voltage is set to be 1.510 volt. After the maximum charging voltage has been determined, subsequent charging cycles of the battery will effectively be terminated when the battery terminal voltage or the charging voltage reaches 1.510 volt, corresponding to a capacity of 46 Ah or approximately 95% of the initial rated capacity.

Furthermore, in order to compensate for the likely diminution in battery capacity due, among other factors, to the increase in battery internal resistance (which will cause the increase in the full charge voltage) as explained above and in order to maintain a maximal battery capacity for optimal performance, the charging voltage margin is reduced by a pre-determined amount for each subsequent pre-determined charging cycles or charging cycle intervals.

In the present specific example, the charging voltage margin is reduced by 5 mV after every subsequent 300 charging cycles. It can be seen from graph B that the life cycle of the battery exceeds 2,000 cycles, compared to the 1,000 cycles of the battery of graph A with each cycle delivering over 80% of the initial rated capacity of the battery. Of course, it will be appreciated that the charging cycles intervals between each adjustment of the instantaneous maximum charging voltage need not be a constant and can be varied as and when desired or necessary. Also, the amount of variation in the maximum charging voltage can be adjusted as and when desired or necessary at the beginning of each new charging cycle interval.

### EXAMPLE TWO (GRAPH C)

In this example, a NiMH battery of 48 Ah rated capacity with a peak characteristic charging voltage of 1.525 volt is also used.

Similar to the charging method as described in Example One above, the characteristic full charge voltage of the battery is measured or ascertained by subjecting the battery to constant current charging at 40 Ah until the characteristic full charge voltage representing full battery capacity has been detected.

After the characteristic full charge voltage (V_{P1}) has been ascertained, subsequent charging cycles of the battery will similarly be terminated upon reaching a pre-determined maximum charging voltage which is below the characteristic full charge voltage V_{P1}. In this specific example, the charging voltage margin is set to be 40 mV below the full charge voltage (V_{P1}). Thus the maximum charging voltage or battery terminal voltage is set to be 1.485 volt, corresponding to 43 Ah or about 90% of the initial rated full battery capacity. Again, similar to the charging of Example One, the maximum charging voltage is revised after a pre-determined number of charging cycles. In this specific example, the maximum charging voltage is increased by 5 mV after every 150 charging cycles. It will be noted from graph C that the life cycles of this battery is extended to over 2,500 cycles.

### EXAMPLE THREE (GRAPH D)

In this example, a NiMH battery of 48 Ah rated capacity with a peak characteristic charging voltage of 1.525 volt is also used.

Similar to the charging as described in Example One above, the full charge voltage of the battery is ascertained by subjecting the battery to constant current charging at 40 Ah until the characteristic full charge voltage representing full battery capacity has been detected. Of course, other charging current, depending on the desired rate of charging, can be used without loss of generality.

After the characteristic full charge voltage (V_{P1}) has been ascertained, subsequent charging cycles of the battery will similarly be terminated upon reaching a pre-determined maximum charging voltage which is below the characteristic full charge voltage V_{P1}. In this specific example, the same constant charging current as used in the characterising cycle is generally used in the subsequent charging cycles and the charging voltage margin is set to be 15 mV below the full charge voltage (V_{P1}). As the subsequent charging current is the same as the charging current used in the characterising cycle, it will be noted that the full charge voltage will be generally the same. Thus the maximum charging voltage or battery terminal voltage is set to be 1.510V, corresponding to 46 Ah or approximately 95% of the initial rated battery capacity. Again, similar to the charging of Example One, the maximum charging voltage is revised after a pre-determined number of charging cycles.

Unlike the above charging methods, the new maximum charging voltage is determined by re-ascertaining or re-measuring the instantaneous characteristic full charge voltage after a pre-determined number of charging cycles has lapsed. The characteristic full charge voltage (V_{P1}) can be measured or ascertained according to known methods, some of which have already been described above. After the new characteristic full charge voltage (V_{P1}) has been determined, subsequent charging cycles are then performed by charging the battery to the maximum charging voltage or maximum on-charge voltage determined from V_{P1}. Similarly, this maximum charging voltage or maximum battery terminal voltage is set to be at a charging voltage margin below the full charge voltage. In this specific example, the charging voltage margin is set to be 5 mV below the new characteristic full charge voltage. As a convenient example, the battery is characterized after 150 charging cycles after the initial characterization. For the revision or updated ascertainment of the subsequent characteristic full charge voltage, subsequent re-characterization of the battery for ascertainment of new characteristic full charge voltages are conducted at 150-cycle intervals. It is noted that the subsequently measured characteristic full charge voltages generally follow an upward trend. The larger initial charging voltage margin of, for example, 15 mV provides a greater margin to accommodate for the initial stabilization period of the battery characteristics. On the other hand, after the battery has undergone a pre-determined number of charging-and-discharging cycles (150 cycles in this example), the electrical characteristics of the battery will be stabilized and a smaller charging voltage margin can be set to further maximize the charging capacity of the batteries. It will be noted from graph D that the life cycles of this battery is extended to over 2,000 cycles.

From the Examples above, and as particularly exemplified by graphs B, C and D, it will be noted that the life cycle of the battery has been significantly extended and the rate of degradation of battery capacity is generally flat until near the end of the battery charge cycle. The present invention avoids this region during battery charging, thereby delivering satisfactory energy level throughout the life of the battery.

The characteristic full charge voltage of the battery is affected by the initial temperature of the cell before charging, the heat capacity and the thermal mass. For batteries of the same construction, only the initial temperature of the cell before charging is generally considered to be important. An example of a suitable charging voltage variation scheme compensate for different cell temperature before charging is set out below:-
Vₘₐₓₜ₁=Vₘₐₓₜ₀+(T₁−T₀)×k
where Vₘₐₓₜ₁=Adjusted maximum charging voltage
T₁=Cell temperature at the start of the charging cycle
Vₘₐₓₜₒ=Full charge voltage at the reference temperature
Tₒ=Cell temperature at the start of the characterising cycle
k=A constant, being the compensation coefficient expressed in mV/° C. This is generally characteristic of the cell construction. For the example test cells, the value is −0.8 mV per ° C.

In Examples Five and Six below, the factor of temperature compensation is introduced in determining the new maximum charging voltage for use in Examples One, Two and Three above.

### EXAMPLE FOUR

In this example, the initial cell temperature before the start of the characterising cycle for determining the characteristic full charge voltage is 25° C. At the end of the characterising cycle, the characteristic full charge voltage is found to be 1.525V. Then, if the cell temperature at the beginning of a charge cycle is 20° C., the temperature adjusted characteristic full charge voltage of the battery should therefore be 1.529V, being 1.525 mV-0.8 mV/° C.×(20-25)° C.

### EXAMPLE FIVE

As another example, if the cell temperature before a charging cycle is 10° C. and the temperature at the beginning of the characterising cycle is 25° C., the temperature adjusted characteristic full charge temperature for determining the maximum charging voltage is therefore 1.533V, being 1.525 v-0.8 mV/° C.×(10-25)° C.

Thus, it can be noted that by using a negative temperature coefficient to adjust the characteristic full charge voltage, and consequently the maximum charging voltage, temperature compensation can be introduced into the charging process.

### EXAMPLE SIX

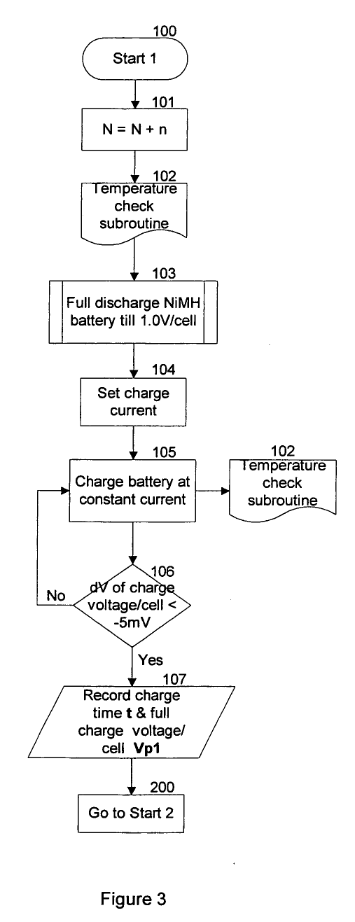

An example of a suitable flow chart demonstrating the operating principles of the charging method or charging apparatus of the present invention is shown in FIGS. 3-5.

Referring to FIG. 3, the flow chart for ascertaining or determining the characteristic full charge voltage (V_{P1}) is shown. A counter is set in step 101 to monitor the number of charging cycles. Before the actual or characterizing charging cycle takes place, the battery temperature is monitored in routine 102 in order to ensure that the battery is operating within its normal operating temperature. At step 103, the battery is fully discharged. By “fully discharged”, it is generally accepted to mean discharged to a minimum acceptable level before the battery will be damaged. For NiMH batteries, discharge to 1.0V per cell is generally accepted to be equivalent to the fully discharged state.

Next, the charging current is set at step 104. The charging current is generally set according to the desired time within which to complete charging. For 1-C rate charging, the current will, for example, be 46 A for the battery of 46 Ah capacity.

After the charging current has been set, the battery will be charged at a constant current which is generally preferable for NiMH batteries.

In order to ascertain the characteristic full charge voltage, the charging voltage or, equivalently, the battery terminal voltage, is monitored from time to time by the voltage sensing or monitoring means to identify for the phenomenon representing the occurrence of the characteristic full charge voltage. In this specific example, the occurrence of a drop of 5 mV in the charging voltage will be used as a confirmation of the occurrence of the characteristic full charge voltage, as shown in step 106. Upon detection of the characteristic full charge voltage, this voltage is recorded and stored in the memory of the charging means, apparatus or system.

At the same time, the initial temperature of the cell and the time required to reach the characteristic full charge voltage of the characterizing cycle are also recorded. The maximum charging time can also be set as an additional safety or security parameter to alleviate the risk of overcharging. To prevent battery overheating or operating below prescribed temperature ranges, the battery temperature is monitored from time to time during the constant current charging step of 105. Upon completion of the characterizing cycle, the routines for subsequent charging of the battery will start at step 200.

Turning now to the temperature routine 102 of FIG. 4. Firstly, the battery temperature is measured by, for example, appropriate temperature sensing means. The measured or sensed battery temperature is then compared with both the appropriate upper limit in step 1022 and the lower limit in step 1023. As an example, the upper and lower temperature limits for a typical NiMH battery are respectively +40° C. and −5° C. If the battery temperature does not exceed the acceptable limits, battery charging and temperature monitoring will continue, as indicated by step 1024. If the battery temperature exceeds the upper limit, cooling will be triggered to lower the temperature, as shown in step 1025. If the battery temperature drops below the lower acceptable limit, heating will be triggered, as indicated by step 1026. Otherwise, charging will have to be suspended to prevent damage to the batteries.

Turning now to the routine for subsequent charging of the battery, as indicated by step 200 of FIG. 5. Firstly, battery temperature is checked by the temperature routine to ensure the battery is within the acceptable temperature range Initially a is set to 0. In order to prevent overcharging of the battery, the maximum charging voltage is set at a pre-determined level or at a charging voltage margin, below the characteristic full charge voltage. This charging voltage margin, which is the difference between the characteristic full charge voltage and the maximum charging voltage in this routine, is set to be 5 mV per cell in the present specific example. This charging voltage margin is set with the competing interest of having maximal charging capacity and minimal damage to the batteries.

With the present control, sensing and monitoring technology, this charging voltage margin can be as low as a few mV's as in the present example. After the maximum charging voltage has been set at step 202, temperature compensated value of the maximum charging voltage is computed, the subsequent charging cycle counter is set so that n=0 in step 204. Firstly, the battery is fully discharged, for example, to 1.0 per cell. In step 206, the battery discharged capacity is monitored during discharging and compared with the 80% capacity threshold. If the battery discharged capacity is above the 80% threshold, the battery will be charged at a constant current, as shown in step 207. The battery terminal voltage is monitored throughout the charging process and the adjusted maximum charging voltage, established according to the principles set out above, is referenced so that the charging voltage does not exceed the temperature compensated maximum charging voltage.

After the cell capacity falls below a critical level, for example 80% in the present example for the first time or, when the battery capacity falls below an expected value, a is set to 1, which causes the maximum charging voltage to be equal to the characteristic full charge voltage without deducting 5 mV. This has the effect of charging the battery to its slightly overcharged state and it is likely that the battery is already near the end of its useful life.

For double security and to ensure that the adjusted maximum charging voltage does not exceed the instantaneous characteristic full charge voltage, the phenomenon indicating the occurrence of the instantaneous characteristic full charge voltage is also monitored in step 209. If phenomenon indicating the occurrence of an instantaneous characteristic full charge voltage have occurred, indicating abnormality, the battery is to be immediately examined and the characterizing routine of 100 will be triggered. On the other hand, if the routine charging of the battery is normal, the instantaneous characteristic full charge voltage will not occur and the battery will be continuously charged until the terminal voltage reaches the temperature adjusted maximum charging voltage in step 210. After the battery has been charged to the temperature adjusted maximum charging voltage, this charging cycle has completed and the counter will be incremented, as indicated in step 211.

If the number of routine charging cycles has not exceeded the pre-determined number of cycles, which is 150 in the present example, the routine charging cycle will be re-triggered for the next charging cycle, as shown by step 212. On the other hand, if the battery has undergone the pre-determined number of charging cycles, re-characterization routine 100 will be triggered. If a new characteristic full charge voltage has been detected in step 209, a new characterization cycle 100 will be re-initiated to re-establish the correct charging parameters.

In step 206, if the measured discharged capacity falls below 80% of the initial rated capacity, the battery is to be charged to the full charing voltage without the 5 mV charging voltage margin per cell at the same time, flag a is incremented by 1. In step 301, the flag a is evaluated, if a equals 2, this means the battery has already been charged without the charging voltage margin before and another below 80% discharging capacity means that the battery can be considered as having reached its end of life in step 303. Before the end of life, the total number of charging cycles is updated in step 302 for tracking purpose.

### EXAMPLE EIGHT

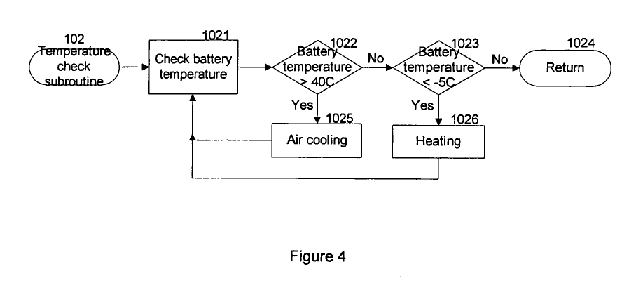

An example of a charging apparatus of the present invention is shown in FIG. 6. The charging apparatus 400 includes a power supply 401 which, in turn includes power converting means and rectifying circuitry. In addition, the apparatus 400 includes a voltage sensing means 402, temperature sensing means 403, current sensing means 404, fuel gauge including analogue-digital converter 405, memory means 406, indicating means 407 and charging control means 408. The charging control means 408 may contain a microprocessor with switching means 409 connected in series between the battery 501 and power source 401. The microprocessor of the charge control means 408 is connected to the various sensing means, for example, via analogue-digital converting means to monitor the battery conditions. In controlling the charging conditions, various important parameters described above are also saved in the memory means so that the charging control means, or the micro-processor, can make appropriate charging decisions with reference to the important parameters described above. The indicating means can, for example, be any appropriate types of indicating means including digital or analogue display. The switching means 409 may include, for example, a MOSFET switching means.

### EXAMPLE NINE

As a further example, the dotted block 500 also shows an intelligent battery including the battery cell 501 and the various component or parts designated by numerals 402-409 in the above examples. With this intelligent battery and the charging control means appropriately programmed, batteries or battery cells with extended life cycles are provided.

While re-characterization or variation of the maximum charging voltage of the battery occurs after a pre-determined number of cycles or upon detection of charging anomalies in the above examples, it will be appreciated that the re-characterization or variation of the maximum charging voltage can occur after a pre-determined period of time without loss of generality.

Since battery operated systems are generally designed to operate at a capacity margin below the full battery capacity level, the maximum charging voltage should therefore be set a level corresponding between the minimum operation capacity and full battery. For example, systems are generally designed with a 20-25% margin, that is, at the minimum of 75-80% battery capacity. Thus the maximum charging voltage should be set to correspond to charging the battery to between 80% to 99.9%, and more preferably between 90% to 99.9%, of the full battery capacityThis generally means that the charging voltage margin is set to be less than 90 mV, and prefereably less than 75 mV, although the charging voltage margin used in the present embodiments is less than 40 mV. In other words, the maximum charging voltage is preferably set to be less than 90 mV, more preferably less than 75 mV and yet more preferably less than 40 mV below the full charge voltage. Of course, the actual maximum charging voltage will be dependent on the actual system margin and operational requirements.

In the preferred embodiments, −ΔV detection of the occurrence of the drop of a few mV's in the on-charge voltage has been used to ascertain the full charge voltage. It should of course be appreciated that other full charge voltage detection schemes, for example, zero ΔV detection, zero slope detection, negative slope detection, or other appropriate schemes or methods are equally applicable.

Although the detection of −ΔV is widely used for determining the end of charge timing, it is noted that the voltage at which the −ΔV condition occurs is variable and due to various factors, including the ambient temperature, the rate of charging current, the battery temperature as well as the number of charging cycles which the battery has undergone. Due to the variable nature of the battery voltage at which the −ΔV condition occurs, and since it is well known that the voltage at which −ΔV occurs will decrease with an increase in the number of charging cycles the battery has undergone. Use of the detection of the −ΔV condition as a criterion for termination of the charging process would not be entirely reliable since there is an obvious risk of overcharging as a result of a decrease in the full charge voltage of the battery due to prolonged use. In order to ensure that a correct full charge voltage is observed from time to time, regular calibration of battery characteristics would be desirable regularly. However, such re-calibration also means repeated overcharging of the battery since the −ΔV condition will only occur after the full charge voltage has occurred. In order to mitigate the adverse effects of ascertaining a charge termination voltage as determined from the detection of the −ΔV condition. A criterion made with reference to the state of charge of the battery is used in the following examples. As is appreciated by a person skilled in the art, the state-of-charge (SOC) of the battery is the available battery capacity of the battery expressed as a percentage of its rated capacity for a new cell or the fully charged capacity of the battery when it was last charged, as determined for example from the current charge-discharge cycle. It is known that the capacity of the battery gradually reduces as the battery ages and the actual battery capacity is also affected by temperature and its charging current rate.

In order to devise an environmentally friendly charging process, characteristic battery data including the rated capacity and other data relating to charging characteristics of the battery such as relationship between the charging current rates, ambient temperatures, battery voltages and state-of-charge of the battery are obtained and collected. After the relevant data has been collected, a full charge voltage of the battery, which corresponds to a state of full charge of the battery, could be ascertained. After the full charge voltage of the battery has been evaluated, a stop-charge voltage can be determined. In determining the stop-charge voltage, a useful criteria is to select a stop-charge voltage which is significantly below the full charge voltage and which is below a voltage at which the rate of increase of battery temperature vis-a-vis the change of voltage begins to increase more rapidly. As is appreciated by persons skilled in the art, the full charge voltage is dependent on the ambient temperature and instantaneous charging current rate.

After the ambient temperature and the charging current rate have been determined, and the stop-charge voltage have been selected according to the above criteria, a controller will operate the charging current source to charge the battery until the stop-charge voltage is reached.

Although the stop-charge voltage is pre-set at a pre-determined voltage value with reference to the full charge voltage, the actual stop-charge voltage can be changed or adjusted by a user for specific applications. In this example, the actual stop-charge voltage can be adjusted by a user with reference to the state-of-charge of the battery. For example, assuming that the stop-charge voltage has been set to correspond to a 85% state-of-charge, a user may instruct the controller to change the stop-charge voltage to a new-stop charge voltage to correspond to, say, 90% of SOC or 80% of SOC. After a new stop-charge SOC has been elected by a user, the new and updated stop-charge voltage can be extrapolated with reference to the state-of-charge of, for example, by extrapolating from graphs constructed by the various data collected at the calibration stage. The setting of the end-of-charge voltage with reference to the SOC of the battery will be explained in further detail below with reference to examples ten and eleven.

### EXAMPLE TEN

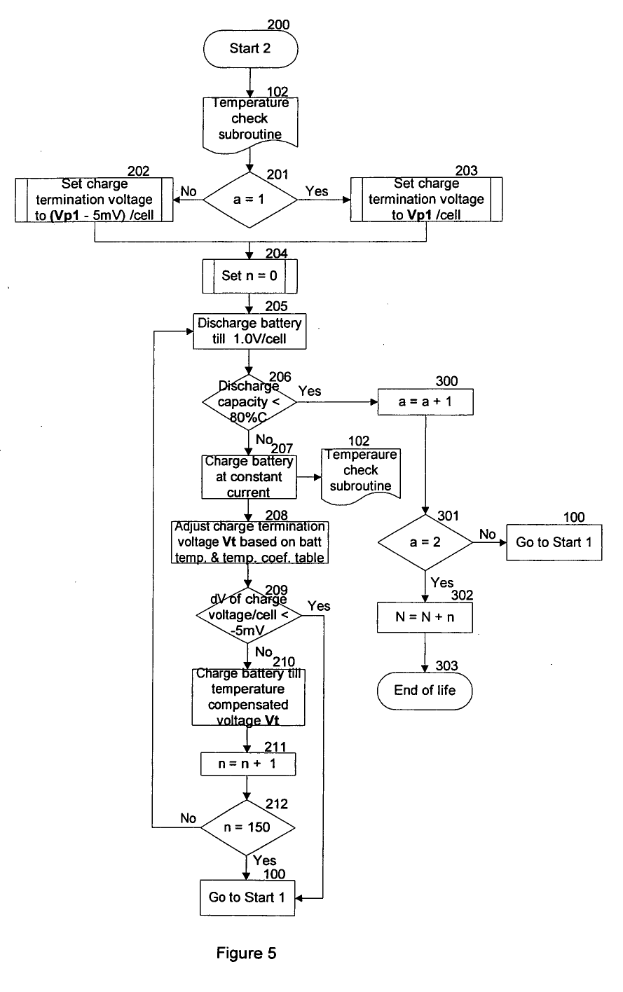

The upper set of graphs of FIG. 7 shows the charging of a Nickel-metal-Hydride Double AA cell at different rates of charging current, i.e. at charging current rates of 0.1 C, 0.5 C and 1 C, and at 25° C. It is noteworthy that as long as the state-of-charge of the battery is maintained below 85% SOC, the temperature of the battery remains relatively constant. When the battery charging is over 85% SOC, the battery temperature begins to rise quite rapidly. It will be appreciated that by charging a battery to a maximum SOC, which corresponds to a SOC at which the battery temperature begins to climb more rapidly, and stop charging, the battery charging process can be maintained at a substantially constant battery temperature. This charging process at a substantially constant temperature is conveniently termed “isothermal charging” in this description.

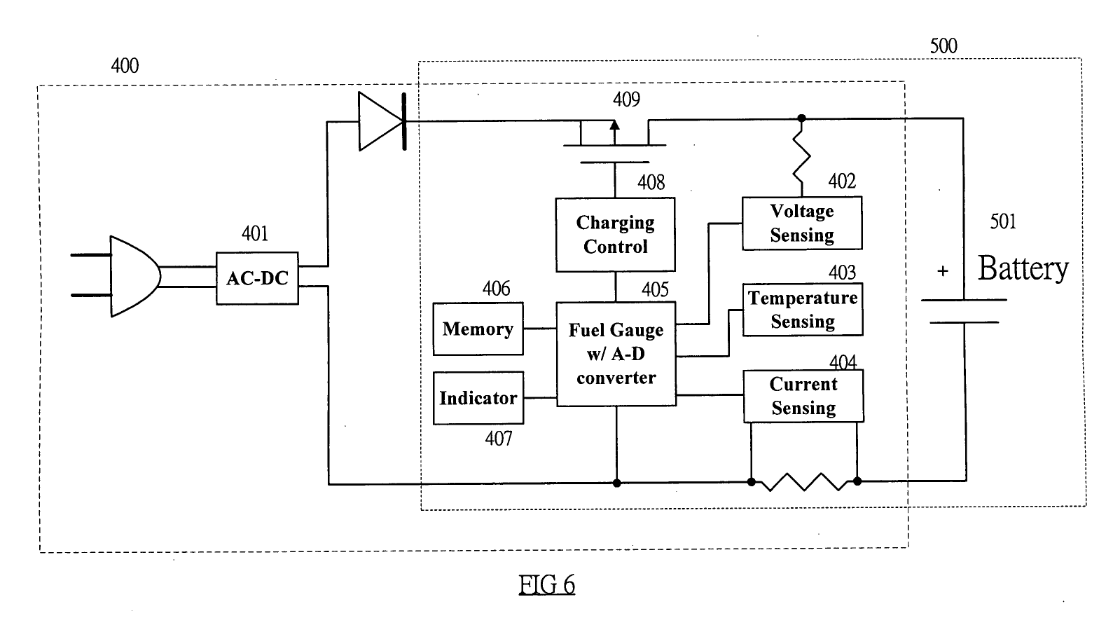

Similarly, the graphs of FIG. 8 show the charging characteristics of the same battery at various C-rates, but at an ambient temperature of 35° C. Again, it will be apparent from the graphs that the temperature of the battery remains substantially constant when the charging is below 85% SOC but will begin to rise more rapidly when a 85% SOC has been reached.

To implement a preferred isothermal battery charging process, relevant battery data, especially battery charging data relating to charging characteristics of the battery, including for example, charging current rates, ambient temperatures, battery temperatures, battery voltages and states-of-charge of the battery, are collected. From the collected data, a prescribed end-of-charge voltage, that is, the voltage at which the battery charging process will terminate, at an ambient temperature and at a selected SOC could be determined, for example, by table look-up, calculation or extrapolation from the collected battery data.

In some applications, it may be preferable or necessary to charge the battery to a higher or a lower capacity. For example, if a prescribed SOC of R % has been selected for a standard charging process and if a higher SOC, say for example, n % SOC is desired, an additional x % SOC will be required after the battery has reached R % SOC. This additional x % SOC, where x=(n-Ref), would be delivered to the battery by applying a constant current source for an extended period of time tₓ, where tₓ=x/l_{c} % hr, where lc is the charging current rate. On the other hand, if a lower SOC of n % SOC is required, x % less SOC should be delivered to the battery before the battery has been charged to the pre-set R % SOC. In such a case, a duration of tₓ, where tₓ=x/l_{c} % hr, should be reduced from the time required to charge the battery to the prescribed SOC.

For example, in this case, the ambient temperature is at 25° C., the charging current and the stop charge SOC are selected as 0.5 C and 85% SOC respectively. From the collected data, the stop-charge voltage for a charging rate of 0.5 C corresponding to 85% SOC is 1.498 volt. Assuming that a 100% SOC is desired, an additional differential capacity of 15% SOC will be required after the 85% SOC voltage of 1.498 volt has been reached. This additional differential capacity of 15% SOC would be supplied by the charging current source at a charging current rate of 0.5 C for an additional charging time of 18 minutes. Similarly, if a SOC of 95% SOC is required, an additional charging time of 12 minutes will be required after the battery has reached the end-of-charge 1.498 volt preset for a 85% SOC. On the other hand, if a lower SOC is required, the end-of-charge voltage can also be determined from the corresponding voltage characteristics.

### EXAMPLE ELEVEN

In this example, a NiMH cell of 3.8 Ah rated capacity with the isothermal charging voltage of 1.498V is used.

Similar to the charging as described in Example Ten above, the pre-determined maximum charging input is ascertained by subjecting the battery to constant current charging at 1.9 A until the characteristic isothermal-set charging voltage representing 85% SOC has been detected. Then the cell is being charged by a constant current at 1.9 A for 12 minutes (10% SOC) to 95% SOC. Other charging current, depending on the desired rate of charging, can be used without loss of generality.

In this specific example, the same constant charging current as used in the characterizing cycle is generally used in the subsequent charging cycles and the charging input margin is set to be 12 minutes at 1.9 A after the isothermal-set charging voltage is reached.

The new isothermal charging is determined by re-ascertaining or re-measuring the instantaneous characteristic pre-determined charging voltage after a pre-determined number of charging cycles has lapsed. In this way, the life cycle of this battery has been significantly extended to over 2000 cycles.

While the present invention has been explained by reference to the preferred embodiments described above, it will be appreciated that the embodiments are only illustrated as examples to assist understanding of the present invention and are not meant to be restrictive on its scope. In particular, the scope, ambit and spirit of this invention are meant to include the general principles of this invention as inferred or exemplified by the embodiments described above. More particularly, variations or modifications which are obvious or trivial to persons skilled in the art, as well as improvements made on the basis of the present invention, should be considered as falling within the scope and boundary of the present invention.

Furthermore, while the present invention has been explained by reference to a NiMH battery, it should be appreciated that the invention can apply, whether with or without modifications, to other batteries without loss of generality.

In addition, while the present invention has been explained by reference to the battery, a charging apparatus and charging methods, it will be appreciated that the scope of the invention includes other systems, wheeled vehicles and apparatus without loss of generality.

1. A method of battery charging comprising the steps of:
a. collecting characteristic battery data of the battery, said characteristic battery data relating to charging characteristics of the battery and including charging current rate, ambient temperature, battery voltage and state-of-charge of the battery;
b. determining a full charge voltage of the battery, said full charge voltage corresponding to a state of full charge of said battery;
c. determining a stop-charge voltage, said stop-charge voltage being below said full charge voltage and being a voltage above which the rate of increase of battery temperature begins to increase;
d. determining the ambient temperature, and selecting a charging current rate; and
e. charging the battery until said stop-charge voltage is reached.

2. A battery charging method according to claim 1, wherein said stop-charge voltage is pre-set at a pre-determined voltage value with reference to a state of charge of said battery, and said stop-charge voltage is adjustable from said pre-determined voltage value by a user to correlate to a target state-of-charge of said battery.

3. A battery charging method according to claim 1, wherein said target state-of-charge of said battery is above 80% but below 100% of the full state-of-charge of said battery.

4. A battery charging method according to claim 1, wherein said stop-charge voltage is a pre-set variable which is pre-determined with reference to the ambient temperature, the charging current rate and an initial target state of charge, and said stop-charge voltage is subsequently variable with reference to a revised target state of charge of said battery which is selectable by a user.

5. A battery charging method according to claim 1, wherein said stop-charge voltage is variable by varying the charging time of said battery with reference to a revised target state of charge of said battery, and said revised target state of charge of said battery is selectable by a user.

6. A battery charging method according to claim 1, wherein said stop voltage is adjustable by extrapolation from said pre-determined voltage value and with reference to the state of full charge of said battery.

7. A battery charging method according to claim 1, wherein said stop-charge voltage is pre-set at a pre-determined value, and said pre-determined value is pre-set at a value which corresponds to a value which is at or below 85% of state of full charge of said battery.

8. A battery charging method according to claim 1, wherein the instantaneous state of full charge of the battery being charged is repeatedly measured during the useful life of said battery.

9. A battery charging method according to claim 8, wherein the instantaneous state of full charge of the battery is determined by battery voltage measurements.

10. A battery charging method according to claim 9, wherein the instantaneous state of full charge of the battery is determined by measurement of the rate of change of battery voltage when under battery charging conditions.

11. A battery charging method according to claim 10, wherein the instantaneous state of full charge of the battery is determined by detection of occurrence of a −ΔV condition.

12. A battery charging method according to claim 8, wherein the value of said stop-charge voltage is revised after measurement of the instantaneous state of full charge of the battery being charged.

13. A battery charger comprising a controller for collecting characteristic battery data, a memory for storing said collected characteristic battery data and a charging current source, said characteristic battery data relating to charging characteristics of the battery and including charging current rate, ambient temperature, battery voltage and state-of-charge of the battery; wherein said controller is adapted to:
a. determine a full charge voltage of the battery, said full charge voltage corresponding to a state of full charge of said battery;
b. determine a stop-charge voltage, said stop-charge voltage being below said full charge voltage and being a voltage above which the rate of increase of battery temperature begins to increase;
c. determine the ambient temperature, and selecting a charging current rate; and
d. control said charging current source to provide charging current to the battery until said stop-charge voltage is reached.

14. A battery charger according to claim 13, wherein said stop-charge voltage is a variable which is pre-determinable from the ambient temperature, the charging current rate and a reference target state-of-charge; and wherein said controller is further adapted to continue to charge said battery beyond said stop-charge voltage for a period of time corresponding to a difference between a revised target state-of-charge and said reference state-of-charge upon receipt of said revised target state-of-charge.

15. A battery charger according to claim 13, wherein said charging current source is a constant current source.

16. A battery charger according to claim 13, wherein said battery is a NiMH battery.

17. A computer comprising the battery charger of claim 13.
